(19) United States
(12) Patent Application Publication
(10) Pub. No.: US 2009/0181254 A1
(43) Pub. Date: Jul. 16, 2009

(54) MULTI-CAPSULE SYSTEM AND ITS USE FOR ENCAPSULATING ACTIVE AGENTS

(75) Inventors: Scott R. White, Champaign, IL (US); Steven Mookhoek, JK Breskens (NL); Sybrand van der Zwaag, ED Schipluiden (NL); Nancy R. Sottos, Champaign, IL (US); Benjamin J. Blaiszik, Urbana, IL (US)

Correspondence Address: EVAN LAW GROUP LLC, 600 WEST JACKSON BLVD., SUITE 625, CHICAGO, IL, 60661, US

(73) Assignee: The Board of Trustees of the University of Illinois, Urbana, IL (US)

(21) Appl. No.: 12/014,573

(22) Filed: Jan. 15, 2008

(51) Int. Cl. B32B 9/00; B01J 13/02

(52) U.S. Cl. 428/402.2; 264/4.1

(57) ABSTRACT

A multi-capsule composition includes a first capsule, which includes a first capsule wall defining a first interior volume and a first fluid in the first interior volume, and a plurality of second capsules, at least partially embedded in the first capsule wall. The second capsules include a second capsule wall defining a second interior volume and a second fluid in the second interior volume. The multi-capsule composition may include at least one active agent, such as pharmaceutical agents, food additives, cleaning agents, complexing agents, personal care substances, lubricants, adhesives, heating/cooling agents, colorants, indicators, superabsorbents, agricultural additives, and healing agents.

### FEDERALLY SPONSORED RESEARCH OR DEVELOPMENT

The subject matter of this application may have been funded in part under a research grant from the Air Force Office of Scientific Research under Grant Number F49620-03-1-0179 and the National Science Foundation under Grant Number DMI 03-28162. The U.S. Government may have rights in this invention.

### BACKGROUND

Microencapsulation of fluids provides for protection of fluids from the external environment, and allows them to be handled and stored as solids rather than as fluids. A wide variety of techniques have been developed to create complex and diverse structures that contain encapsulated fluids. These techniques include the use of materials such as polymers, lipids and silica to encapsulate various organic or inorganic liquids in core-shell particles. Other complex structures include multi-core capsules and onion-like designs.

Microencapsulation is particularly useful for fluids that contain an active agent that is capable of carrying out a function when exposed to the external environment. Microcapsules may be used for the protection and/or targeted release of fluids for applications such as pharmaceutical therapies, food additives, cleaning, complexing, personal care, lubrication, adhesives, heating and cooling, printing, environmental sensing, superabsorbancy and agricultural additives.

A recent application of microencapsulation has been in the area of autonomically self-healing materials. Cracks that form within materials can be difficult to detect and almost impossible to repair. A variety of self-healing materials have been developed that include one or more healing agents present in microcapsules. Healing agents may include, for example, a polymerizer, an activator for the polymerizer, and/or a solvent. When a crack propagates through a material containing the microencapsulated healing agent, it ruptures the microcapsules and releases healing agent into the crack plane. The healing agent may then contribute to the bonding of the crack faces, to provide structural continuity where the crack had been.

A challenge in using microencapsulated fluids can arise when two or more fluids are needed for a particular application. For example, in self-healing materials it is desirable to isolate a polymerizer from its corresponding activator in the material matrix, while still providing for sufficient contact between the polymerizer and activator when a crack is formed in the matrix. In particular, it can be challenging to ensure that the activator is protected during the formation and use of the composite, and that it is sufficiently distributed within the matrix so as to be available to form a polymer with the polymerizer in the crack plane. In another example, it may be desirable to provide sustained and/or targeted release of two or more pharmaceutical agents for a pharmaceutical therapy. In this example, it may be critical to provide the pharmaceutical agents within a particular range of ratios, but without allowing the agents to be in contact prior to their release. In yet another example, it may be desirable to release one fluid prior to the release of another fluid. For example, a microencapsulated fragrance for attracting insects may be released prior to the release of a microencapsulated pesticide.

It is desirable to provide microcapsules that include two different fluids that are isolated from each other. Ideally, such microcapsules will release the two fluids in a controllable way, such as through sequential release, simultaneous release, or a more complex release profile.

### SUMMARY

In one aspect, the invention provides a multi-capsule composition including a first capsule, which includes a first capsule wall defining a first interior volume and a first fluid in the first interior volume, and a plurality of second capsules, at least partially embedded in the first capsule wall. The second capsules include a second capsule wall defining a second interior volume and a second fluid in the second interior volume.

In another aspect, the invention provides a method of making a multi-capsule composition including forming an emulsion that includes a first fluid, a plurality of second capsules, and a continuous fluid that is immiscible with the first fluid. The second capsules include a second capsule wall defining a second interior volume and a second fluid in the second interior volume. At least a portion of the second capsules are at an interface between the first fluid and the continuous fluid. The method further includes forming a first capsule wall at the interface, where the first capsule wall defines an interior volume that includes at least a portion of the first fluid.

In yet another aspect, the invention provides a composite material including a polymer matrix and a multi-capsule composition. The multi-capsule composition may include a healing agent.

In yet another aspect, the invention provides a method of making a composite material including combining a multi-capsule composition with a matrix precursor, and solidifying the matrix precursor to form a polymer matrix.

In yet another aspect, the invention provides an article including a composite material that includes a polymer matrix and a multi-capsule composition. The multi-capsule composition may include a healing agent.

The following definitions are included to provide a clear and consistent understanding of the specification and claims.

The term “capsule” means a closed object having an aspect ratio of 1:1 to 1:10, and that may contain a solid, liquid, gas, or combinations thereof. The aspect ratio of an object is the ratio of the shortest axis to the longest axis, where these axes need not be perpendicular. A capsule may have any shape that falls within this aspect ratio, such as a sphere, a toroid, or an irregular ameboid shape. The surface of a capsule may have any texture, for example rough or smooth.

The term “average” of a dimension of a plurality of capsules means the average of that dimension for the plurality. For example, the term “average diameter” of a plurality of capsules means the average of the diameters of the capsules, where a diameter of a single capsule is the average of the diameters of that capsule. Likewise, the term “average wall thickness” of a plurality of capsules means the average of the wall thicknesses of the capsules, where a wall thickness of a single capsule is the average of the wall thicknesses of that capsule.

The term “healing agent” means a substance that can contribute to the restoration of structural integrity to an area of a material that has been subjected to a crack. Examples of healing agents include polymerizers, activators for polymerizers, and solvents.

The term “polymerizer” means a composition that will form a polymer when it comes into contact with a corresponding activator for the polymerizer. Examples of polymerizers include monomers of polymers, such as styrene, ethylene, acrylates, methacrylates and dicyclopentadiene (DCPD); one or more monomers of a multi-monomer polymer system, such as diols, diamines and epoxides; prepolymers such as partially polymerized monomers still capable of further polymerization; and functionalized polymers capable of forming larger polymers or networks.

The term “activator” means anything that, when contacted or mixed with a polymerizer, will form a polymer. Examples of activators include catalysts and initiators. A corresponding activator for a polymerizer is an activator that, when contacted or mixed with that specific polymerizer, will form a polymer.

The term “catalyst” means a compound or moiety that will cause a polymerizable composition to polymerize, and that is not always consumed each time it causes polymerization. This is in contrast to initiators, which are always consumed at the time they cause polymerization. Examples of catalysts include ring opening metathesis polymerization (ROMP) catalysts such as Grubbs catalyst. Examples of catalysts also include silanol condensation catalysts such as titanates and dialkyltincarboxylates. A corresponding catalyst for a polymerizer is a catalyst that, when contacted or mixed with that specific polymerizer, will form a polymer.

The term “solvent”, in the context of a healing agent, means a liquid that can dissolve another substance, and that is not a polymerizer.

The term “initiator” means a compound or moiety that will cause a polymerizable composition to polymerize and, in contrast to a catalyst, is always consumed at the time it causes polymerization. Examples of initiators include peroxides, which can form a radical to cause polymerization of an unsaturated monomer; a monomer of a multi-monomer polymer system, such as a diol, a diamine, and an epoxide; and amines, which can form a polymer with an epoxide. A corresponding initiator for a polymerizer is an initiator that, when contacted or mixed with that specific polymerizer, will form a polymer.

The term “emulsion” means a combination of at least two fluids, where one of the fluids is present in the form of droplets in the other fluid. The term “emulsion” includes microemulsions.

The term “matrix” means a continuous phase in a material.

The term “matrix precursor” means a composition that will form a matrix when it is solidified. A matrix precursor may include a monomer and/or prepolymer that can polymerize to form a polymer matrix. A matrix precursor may include a polymer that is dissolved or dispersed in a solvent, and that can form a polymer matrix when the solvent is removed. A matrix precursor may include a polymer at a temperature above its melt temperature, and that can form a polymer matrix when cooled to a temperature below its melt temperature.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a schematic representation of a cross-section of a multi-capsule composition.

FIG. 2 is a schematic representation of a cross-section of a multi-capsule composition including second capsules that are at least partially in the first interior volume.

FIG. 3 is a schematic representation of a cross-section of a multi-capsule composition including second capsules that are in contact with the exterior of the first capsule wall.

FIG. 4 is schematic representation of a cross-section of a multi-capsule composition including an additional set of capsules.

FIG. 5 is an illustration of a self-healing composite, in which a crack has been initiated (FIG. 5A), in which the crack has progressed to release a healing agent (FIG. 5B), and in which the crack has been healed by the formation of a polymer from the healing agent (FIG. 5C).

FIG. 6 is a scanning electron microscopy (SEM) image of microcapsules that may be used as Pickering stabilizers.

FIG. 7 is a plot of the size distribution for the microcapsules of FIG. 6.

FIG. 8 is a SEM image of multi-capsules.

FIG. 9 is a plot of the size distribution for the multi-capsules of FIG. 8.

FIG. 10 is a fluorescent mode micrograph of multi-capsules.

FIG. 11 is a SEM image of a fractured multi-capsule composition embedded in an epoxy matrix.

FIG. 12 is a SEM image of a multi-capsule composition in which spherical structures are visible in a polyurethane capsule wall.

FIG. 13 is a graph of Differential Scanning Calorimetry (DSC) data and Thermo-Gravimetric Analysis (TGA) data for a multi-capsule composition.

### DETAILED DESCRIPTION

The present invention is based on the discovery that capsules containing a fluid can be used to form colloidosomes in which the capsules are present at an interface between two immiscible fluids. A multi-capsule composition can be formed from the colloidosome by forming a capsule wall at the interface. Such multi-capsule compositions may include a first fluid within this capsule wall, and may include a second fluid in the capsules at the interface. The multi-capsule system may be used for delivery of one or more active agents, such as a pharmaceutical agent for an organism, or a healing agent for a self-healing material.

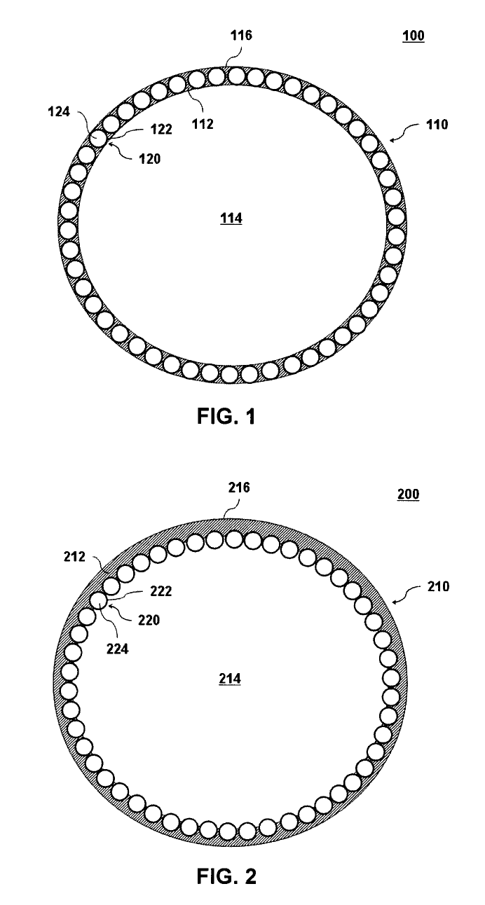

FIG. 1 is a schematic representation of a cross-section of a multi-capsule composition 100 that includes a first capsule 110 and a plurality of second capsules 120. The first capsule 110 includes a first capsule wall 112 defining a first interior volume 114 and having an exterior 116. A first fluid is in the first interior volume 114. The second capsules 120 include a second capsule wall 122 defining a second interior volume 124, and a second fluid in the second interior volume. The second capsules 120 are at least partially embedded in the first capsule wall 112.

The first capsule 110 preferably has a diameter of from 10 nanometers (nm) to 1 millimeter (mm), more preferably from 5 to 700 micrometers, more preferably from 30 to 500 micrometers, and more preferably from 50 to 300 micrometers. The first capsule preferably has an aspect ratio of from 1:1 to 1:10, more preferably from 1:1 to 1:5, more preferably from 1:1 to 1:3, more preferably from 1:1 to 1:2, and more preferably from 1:1 to 1:1.5.

The first capsule wall 112 may be any material useful for forming capsules. Examples of capsule wall materials include polymers, ceramics and mixtures of these. Examples of polymers that may be present in the first capsule wall include polyurethane, urea-formaldehyde polymer, gelatin, polyurea, polystyrene, polydivinylbenzene, and polyamide. The first capsule wall 112 preferably has a thickness of from 50 nm to 10 micrometers.

The selection of materials and properties for the first capsule 110 may depend on a variety of parameters, such as the chemical composition of the first fluid, the conditions for storage and handling of the multi-capsule composition, the final application of the multi-capsule composition or of a product containing the multi-capsule composition, and the properties of the second capsules. For example, first capsule walls 112 that are too thick may not rupture when the release of the contents of the first capsule is desired, while first capsule walls that are too thin may break during processing. In another example, first capsules that have a small diameter may not deliver sufficient amounts of the first fluid, while first capsules that have a large diameter may be blocked from delivering the first fluid to locations having small dimensions.

The first fluid in the first interior volume 114 may be a liquid or a gas. Preferably the first fluid is a liquid. The first fluid may include, for example, a solvent, an active agent, particles and/or other substances. For example, the first fluid may include an emulsion. Preferably the first fluid does not dissolve the first capsule wall 112. The first fluid may permeate the first capsule wall, or the first capsule wall may be impermeable to the first fluid.

The second capsules 120 preferably have an average diameter less than 10 micrometers. More preferably, the second capsules 120 have an average diameter from 10 nm to less than 10 micrometers, more preferably from 10 nm to 5 micrometers, more preferably from 10 nm to 2.5 micrometers, and more preferably from 10 nm to 200 nm. The second capsules preferably have an average aspect ratio of from 1:1 to 1:10, more preferably from 1:1 to 1:5, more preferably from 1:1 to 1:3, more preferably from 1:1 to 1:2, and more preferably from 1:1 to 1:1.5.

The average diameter of the first capsule 110 preferably is greater than the average diameter of the second capsules 120. More preferably, the average diameter of the first capsule 110 is at least one order of magnitude greater than the average diameter of the second capsules 120. More preferably, the average diameter of the first capsule 110 is at least two orders of magnitude greater than the average diameter of the second capsules 120.

The second capsule wall 122 may be any material useful for forming capsules, as described for the first capsule wall 112. The first and second capsule walls may be the same material, or they may be different materials. The walls 122 of the second capsules preferably have an average thickness of from 30 nm to 150 nm, more preferably from 50 nm to 90 nm.

The selection of materials and properties for the second capsules 120 may depend on a variety of parameters, such as the chemical composition of the second fluid, the conditions for storage and handling of the multi-capsule composition, the final application of the multi-capsule composition or of a product containing the multi-capsule composition, and the properties of the first capsule. For example, second capsule walls 122 that are too thick may not rupture when the release of the contents of the capsules is desired, while second capsule walls that are too thin may break during processing. In another example, second capsules that have a small diameter may not deliver sufficient amounts of the second fluid, while second capsules that have a large diameter may not be able to form a complete layer at the first capsule wall 112.

The second fluid in the second interior volume 124 may be a liquid or a gas. Preferably the second fluid is a liquid. The second fluid may include, for example, a solvent, an active agent, particles and/or other substances. For example, the second fluid may include an emulsion. Preferably the second fluid does not dissolve the second capsule wall 122. The second fluid may permeate the second capsule wall, or the second capsule wall may be impermeable to the second fluid.

The second capsules 120 are at least partially embedded in the first capsule wall 112. At least a portion of the second capsules may be completely embedded in the first capsule wall 112. At least a portion of the second capsules may be partially embedded in the first capsule wall 112 and in contact with the first interior volume 114. At least a portion of the second capsules may be partially embedded in the first capsule wall 112 and in contact with the exterior of the first capsule wall 112. A single multi-capsule composition 100 may include second capsules 120 that are in contact with the first interior volume 114, it may include second capsules 120 that are in contact with the exterior of the first capsule wall 112, and/or it may include second capsules 120 that are completely embedded in the first capsule wall 112.

The multi-capsule composition 100 may further include additional second capsules 120 that are not at least partially embedded in the first capsule wall 112. Additional second capsules may be in contact with the first interior volume 114. Additional second capsules may be in contact with or at a distance from the exterior 116 of the first capsule wall. Additional second capsules may form a layer on the interior and/or exterior of the first capsule wall 112. This layer may include sufficient additional second capsules to provide from 1 to 10 monolayers of the additional second capsules. Preferably the layer, if present, provides from 1 to 5 monolayers or from 1 to 3 monolayers of the additional second capsules.

The multi-capsule composition 100 may include an active agent. The first and second fluids independently may include an active agent. If both the first and second fluids include an active agent, the active agents in each fluid may be the same, or they may be different. Examples of active agents include pharmaceutical agents, food additives, cleaning agents, complexing agents, personal care substances, lubricants, adhesives, heating/cooling agents, colorants, indicators, superabsorbents, agricultural additives, and healing agents.

An active agent in a multi-capsule composition may include a pharmaceutical agent. Examples of pharmaceutical agents include nucleic acids, proteins and peptides, hormones and steroids, chemotherapeutics, NSAIDs, vaccine components, analgesics, antibiotics and anti-depressants. It may be especially useful to encapsulate hydrophobic pharmaceutical agents, as these may be difficult to deliver to aqueous regions of an organism. It may be especially useful to encapsulate pharmaceutical agents that are susceptible to denaturation, such as proteins and peptides (including hormones), and nucleic acids.

In one example, it may be desirable to provide sustained release of one or more pharmaceutical agents. In this example, at least one of the first and second capsule walls may include a biodegradable polymer. Control of the release of the pharmaceutical agent(s) from the multi-capsule composition may be obtained by controlling the relative thicknesses of the capsule walls and by controlling the polymeric composition of the capsule walls. If each of the first and second fluids contains a different pharmaceutical agent, the capsule walls may, for example, serve to keep the pharmaceutical agents separate until they are released from the composition. The capsule walls may be designed to permit a pharmaceutical agent in the first capsule to be released only by diffusion through the second capsules. In this example, the second capsules may serve as a controlled diffusion barrier, or the second capsules may include a different active agent that interacts with the pharmaceutical agent from the first capsule prior to its release from the multi-capsule composition.

An active agent in a multi-capsule composition may include a food additive. Examples of food additives include flavorants and dietary supplements. Examples of dietary supplements include amino acids, vitamins, minerals, antioxidants, glucosamine, glycosaminoglycans, probiotics, and herbal extracts.

An active agent in a multi-capsule composition may include a cleaning agent. Examples of cleaning agents include surfactants, silicones, and sanitizing agents. Examples of surfactants include cationic surfactants, anionic surfactants, amphoteric surfactants and non-ionic surfactants. Examples of sanitizing agents include antimicrobial agents, alcohols, and catalytic particles.

An active agent in a multi-capsule composition may include a complexing agent. Examples of complexing agents include chelating agents, such as ethylenediaminetetraacetic acid (EDTA); crown compounds, such as crown ethers and aza-crowns; and cyclodextrins.

An active agent in a multi-capsule composition may include a personal care substance. Examples of personal care substances include fragrances, skin-care additives, botanicals, astringents, moisturizers and emollients. An active agent in a multi-capsule composition may include a lubricant. Examples of lubricants include hydrocarbon oils, vegetable oils, synthetic polymers, graphite, and molybdenum disulfide. An active agent in a multi-capsule composition may include an adhesive. Examples of adhesives include natural polymers and synthetic polymers, such as starches, polyacrylates and polyurethanes.

An active agent in a multi-capsule composition may include a heating and/or cooling agent. Examples of heating agents include substances that can undergo an exothermic reaction. Examples of cooling agents include substances that can undergo an endothermic reaction. For example, a heating or cooling agent in one capsule may undergo an exothermic or endothermic reaction, respectively, when contacted with the environment surrounding the multi-capsule composition, or when contacted with a different substance from another capsule. Examples of heating/cooling agents also include phase-change materials (PCMs), which can store heat or heat capacity when maintained at a temperature just above or below their melting temperature, respectively. Examples of PCMs that can be used as heating and/or cooling agents when encapsulated include paraffin waxes, salt hydrates, and ionic liquids.

An active agent in a multi-capsule composition may include a colorant. Examples of colorants include dyes and pigments. An active agent in a multi-capsule composition may include an indicator, such as a substance having at least one property that changes in a detectable way in response to changes in the surrounding environment. Examples of indicators include pH indicators and thermochromic materials. An active agent in a multi-capsule composition may include a superabsorbent. Examples of superabsorbents include polymers such as poly(acrylic acid), polyacrylamide, carboxyalkyl cellulose, and poly(vinyl alcohol). An active agent in a multi-capsule composition may include an agricultural additive. Examples of agricultural additives include fertilizers, pesticides and herbicides.

The multi-capsule composition 100 may include a healing agent, such as a healing agent for a self-healing material. Healing agents may include, for example, a polymerizer, an activator for the polymerizer, and/or a solvent. In one example, one of the first fluid and the second fluid includes a polymerizer, and the other fluid includes an activator for the polymerizer. In another example, one of the first fluid and the second fluid includes a polymerizer, and the other fluid includes a solvent.

A polymerizer in the multi-capsule composition 100 may include a polymerizable substance such as a monomer, a prepolymer, or a functionalized polymer having two or more reactive groups. For example, a polymerizer may include a polymerizable substance that includes reactive groups such as alkene groups, epoxide groups, amine groups, phenol groups, aldehyde groups, hydroxyl groups, carboxylic acid groups, and/or isocyanate groups. Examples of polymerizable substances also include lactones (such as caprolactone) and lactams, which, when polymerized, will form polyesters and nylons, respectively.

Examples of polymerizable substances include alkene-functionalized monomers, prepolymers or polymers, which may form a polymer when contacted with other alkene groups. Examples of alkene-functionalized polymerizers include monomers such as acrylates; alkylacrylates including methacrylates and ethacrylates; olefins including styrenes, isoprene and butadiene; and cyclic olefins including dicyclopentadiene (DCPD), norbornene and cyclooctadiene. Examples of alkene-functionalized polymerizers also include diallyl phthalate (DAP), diallyl isophthalate (DAIP), triallyl isocyanurate, hexane dioldiacrylate (HDDA), trimethylol propanetriacrylate (TMPTA), and epoxy vinyl ester prepolymers and polymers.

Examples of polymerizable substances also include functionalized siloxanes, such as siloxane prepolymers and polysiloxanes having two or more reactive groups. Functionalized siloxanes include, for example, silanol-functional siloxanes, alkoxy-functional siloxanes, and allyl- or vinyl-functional siloxanes. Self-healing materials that include functionalized siloxanes as polymerizers are disclosed, for example, in U.S. Patent Application Publication 2006/0252852 A1 with inventors Braun et al., published Nov. 9, 2006; and in U.S. Patent Application Publication 2007/0166542 A1 with inventors Braun et al., published Jul. 19, 2007. A healing agent including a functionalized siloxane polymerizer may contain a multi-part polymerizer, in which two or more different substances react together to form a polysiloxane when contacted with an activator. In one example of a multi-part polymerizer, at least one part of the polymerizer can be a polymer containing two or more functional groups. For example, a silanol-functional polysiloxane can react with an alkoxy-functional polysiloxane to form a polysiloxane network. In the reaction of hydroxyl terminated polydimethylsiloxane (HOPDMS) with polydiethylsiloxane (PDES), an activator such as dibutyltin dilaurate provides for elimination of ethanol and formation of a polydimethylsiloxane network. In the example of a two-part siloxane polymerizer, each of the two parts of the polymerizer may be in separate capsules. The activator for the polymerizer may be in one of these capsules, or it may be in one or more additional capsules.

Examples of polymerizable substances also include epoxide-functionalized monomers, prepolymers or polymers, which may form an epoxy polymer when contacted with amine groups. For example, an epoxy polymer can be formed by the reaction at or below room temperature (for example, 25° C.) of one compound containing two or more epoxy functional groups with another compound containing either at least one primary amine group or at least two secondary amine groups. Examples of epoxide-functionalized polymerizers include diglycidyl ethers of bisphenol A (DGEBA), such as EPON® 828; diglycidyl ethers of bisphenol F (DGEBF), such as EPON® 862; tetraglycidyl diaminodiphenylmethane (TGDDM); and multi-glycidyl ethers of phenol formaldehyde novolac polymers, such as SU-8. Self-healing materials that include epoxide-functionalized polymerizers are disclosed, for example, in copending U.S. Provisional Patent Application Ser. No. 60/983,004, filed Oct. 26, 2007.

Examples of polymerizable substances also include amine-functionalized monomers, prepolymers or polymers, which may form an epoxy polymer when contacted with epoxide groups, or which may form an amino polymer when contacted with aldehyde groups. Examples of amine-functionalized polymerizers include aliphatic and aromatic diamines, triamines, and tetramines. Specific examples of amine-functionalized polymerizers include ethanediamine, triethylenetriamine, diethylenetriamine (DETA), hexamethylenetetramine, tetraethylenepentamine (TEPA), urea, melamine, and amine-terminated polymers or prepolymers such as α-aminomethylethyl-ω-aminomethylethoxy-poly[oxy(methyl-1,2-ethanediyl)].

Examples of polymerizable substances also include phenol-functionalized monomers, prepolymers or polymers, which may form a phenol-formaldehyde polymer when contacted with aldehyde groups, or which may form a polymer when contacted with amine groups. Examples of phenol-functionalized polymerizers include novolac polymers and resole polymers.

Examples of polymerizable substances also include aldehyde-functionalized monomers, prepolymers or polymers, which may form a phenol-formaldehyde polymer when contacted with phenol groups, or which may form an amino polymer when contacted with amine groups. Examples of aldehyde-functionalized polymerizers include formaldehyde, and include aldehyde-terminated dendrimers such as ald-PAMAM.

Examples of polymerizable substances also include hydroxyl-functionalized monomers, prepolymers or polymers, which may form a polyester when contacted with carboxylic acid or anhydride groups, or which may form a polyurethane when contacted with isocyanate groups. Examples of hydroxyl-functionalized polymerizers include poly(ethylene glycol), poly(propylene glycol), glycerol, 1,4-butanediol, pentaerythritol, and saccharides.

Examples of polymerizable substances also include carboxylic acid-functionalized monomers, prepolymers or polymers, which may form a polyester when contacted with hydroxyl groups. Examples of carboxylic acid-functionalized polymerizers include oxalic acid, malonic acid, succinic acid, glutaric acid, adipic acid, maleic acid, and phthalic acid. Examples of polymerizable substances also include anhydride-functionalized monomers, prepolymers or polymers, which may form a polyester when contacted with hydroxyl groups. Examples of anhydride-functionalized polymerizers include oxalic anhydride, malonic anhydride, succinic anhydride, glutaric anhydride, adipic anhydride, maleic anhydride, and phthalic anhydride.

Examples of polymerizable substances also include isocyanate-functionalized monomers, prepolymers or polymers, which may form a polyurethane when contacted with hydroxyl groups. In one example, the polymerizer may be a compound containing both an isocyanate group and a hydroxyl group. In another example, the polymerizer may include two different compounds, one compound containing at least two isocyanate groups and the other compound containing at least two hydroxyl groups. Examples of isocyanate-functionalized polymerizers include hexamethylene diisocyanate (HDI), toluene diisocyanate (TDI), methylene diphenyl diisocyanate (MDI), isophorone diisocyanate (IPDI), phenylene diisocyanate, and 1,4-diisocyanatobutane.

An activator in a multi-capsule composition 100 may include a general activator for polymerization, or it may include a corresponding activator for a specific polymerizer present in the multi-capsule composition. If the activator is present in the multi-capsule composition, it is preferably a corresponding activator for a polymerizer that is present in the composition. The activator may be a catalyst or an initiator.

Examples of activators include corresponding catalysts for polymerizable cyclic olefins, including ring opening metathesis polymerization (ROMP) catalysts such as Schrock catalysts and Grubbs catalysts. Examples of activators include corresponding catalysts for lactones and lactams, including cyclic ester polymerization catalysts and cyclic amide polymerization catalysts such as scandium triflate.

Examples of activators include corresponding catalysts for the polymerization of silanol-functional siloxanes with alkoxy-functional siloxanes, such as catalysts that promote silanol condensation or the reaction of silanol with alkoxy-functional siloxane groups. Examples of these catalysts include amines and include metal salts, where the metal can be lead, tin, zirconium, antimony, iron, cadmium, calcium, barium, manganese, bismuth or titanium.

Examples of activators include two-part activators, in which two distinct substances must be present in combination for the activator to function. In one example of a two-part activator system, one part of a catalyst may be a tungsten compound, such as an organoammonium tungstate, an organoarsonium tungstate, or an organophosphonium tungstate; or a molybdenum compound, such as organoammonium molybdate, an organoarsonium molybdate, or an organophosphonium molybdate. The second part of the catalyst may be an alkyl metal halide, such as an alkoxyalkyl metal halide, an aryloxyalkyl metal halide, or a metaloxyalkyl metal halide in which the metal is independently tin, lead, or aluminum; or an organic tin compound, such as a tetraalkyltin, a trialkyltin hydride, or a triaryltin hydride.

In another example of a two-part activator system, a corresponding polymerizer may contain alkene-functional polymerizers. In this example, atom transfer radical polymerization (ATRP) may be used, with one of the activator components being mixed with the polymerizable compound, and the other activator component acting as the initiator. One component can be an organohalide such as 1-chloro-1-phenylethane, and the other component can be a copper(I) source such as copper(I) bipyridyl complex. In another exemplary system, one activator component could be a peroxide such as benzoyl peroxide, and the other activator component could be a nitroxo precursor such as 2,2,6,6-tetramethylpiperidinyl-1-oxy. These systems are described in Stevens (1999, pp. 184-186).

In another example of a two-part activator system, a corresponding polymerizer may contain isocyanate functional groups (—N═C═O) and hydroxyl functional groups (—OH), which can react to form a urethane linkage (—NH—C(═O)—O—). In this system, condensation polymerization may be used, with one of the activator components being mixed with the polymerizer, and the other activator component acting as the initiator. For example, one component could be an alkylating compound such as stannous 2-ethylhexanoate, and the other component could be a tertiary amine such as diazabicyclo[2.2.2]octane. These systems are described in Stevens (1999, pp. 378-381).

An activator in a multi-capsule composition 100 may include a solvent. The solvent may be an aprotic solvent, a protic solvent, or a mixture of these. Examples of aprotic solvents include hydrocarbons, such as cyclohexane; aromatic hydrocarbons, such as toluene and xylenes; halogenated hydrocarbons, such as dichloromethane; halogenated aromatic hydrocarbons, such as chlorobenzene and dichlorobenzene; substituted aromatic solvents, such as nitrobenzene; ethers, such as tetrahydrofuran (THF) and dioxane; ketones, such as acetone and methyl ethyl ketone; esters, such as ethyl acetate and phenyl acetate; tertiary amides, such as dimethyl acetamide (DMA), dimethyl formamide (DMF) and N-methyl pyrrolidine (NMP); nitriles, such as acetonitrile; and sulfoxides, such as dimethyl sulfoxide (DMSO). Examples of protic solvents include water; alcohols, such as ethanol, isopropanol, butanol, cyclohexanol, and glycols; and primary and secondary amides, such as acetamide and formamide. Examples of healing agents that include a solvent are disclosed, for example, in copending U.S. Provisional Patent Application Ser. No. 60/983,004, filed Oct. 26, 2007.

The multi-capsule composition 100 may include at least one other ingredient. Examples of other ingredients that may be in the multi-capsule composition 100 include stabilizers, viscosity modifiers such as polymers, inorganic fillers, odorants, blowing agents, antioxidants, and co-catalysts. One or more other ingredients independently may be present in the first and/or second fluids.

FIG. 2 is a schematic representation of a cross-section of a multi-capsule composition 200 that includes a first capsule 210 including a first capsule wall 212 defining a first interior volume 214 and having an exterior 216, and a plurality of second capsules 220 including a second capsule wall 222 defining a second interior volume 224. A first fluid is in the first interior volume 214, and a second fluid is in the second interior volume 224. The second capsules 220 are at least partially embedded in the first capsule wall 212, and at least a portion of the second capsules are in contact with the first interior volume 214. The composition 200 may further include additional second capsules 220 in contact with the first interior volume 214.

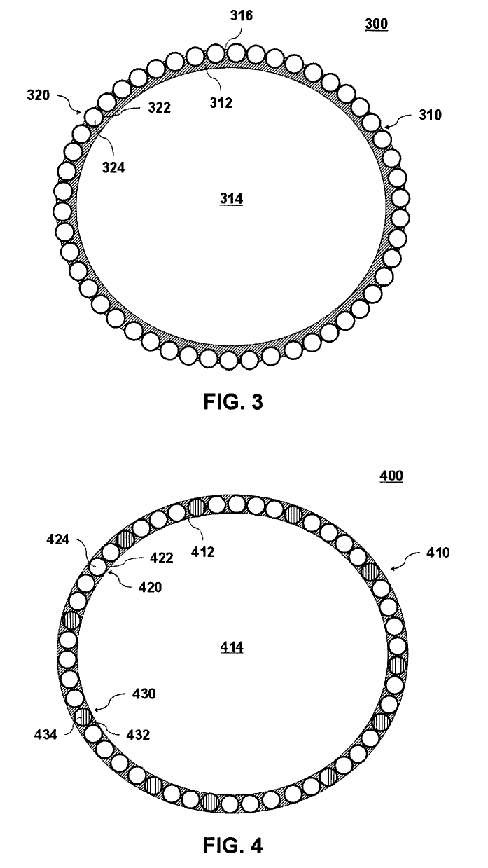

FIG. 3 is a schematic representation of a cross-section of a multi-capsule composition 300 that includes a first capsule 310 including a first capsule wall 312 defining a first interior volume 314 and having an exterior 316, and a plurality of second capsules 320 including a second capsule wall 322 defining a second interior volume 324. A first fluid is in the first interior volume 314, and a second fluid is in the second interior volume 324. The second capsules 320 are at least partially embedded in the first capsule wall 312, and at least a portion of the second capsules are in contact with the exterior 316 of the first capsule wall 312. The composition 300 may further include additional second capsules 320, which may be in contact with or at a distance from the exterior 316 of the first capsule wall 312.

A multi-capsule composition may include a first capsule, a plurality of second capsules, and a plurality of at least one additional set of capsules. For example, a multi-capsule composition may include a first capsule, a plurality of second capsules, and a plurality of third capsules in contact with at least a portion of the plurality of second capsules. The selection of the composition and properties of the at least one additional set of capsules may depend on a variety of parameters, similar to those noted above for the first and second capsules. An additional set of capsules may, for example, provide physical stability to a multi-capsule composition. An additional set of capsules may, for example, contain a different active agent that provides additional functionality to the active agent(s) in the first and/or second capsules.

FIG. 4 is schematic representation of a cross-section of a multi-capsule composition 400 that includes a first capsule 410, a plurality of second capsules 420, and a plurality of third capsules 430 in contact with at least a portion of the plurality of second capsules. The first capsule 410 includes a first capsule wall 412 defining a first interior volume 414, and a first fluid in the first interior volume. The second capsules 420 include a second capsule wall 422 defining a second interior volume 424, and a second fluid in the second interior volume. The second capsules 420 are at least partially embedded in the first capsule wall 412. The third capsules 430 include a third capsule wall 432 defining a third interior volume 434, and a third fluid in the third interior volume.

The first capsule 410 and second capsules 420 may be as described above for first capsules and second capsules, respectively. The third capsules 430 may be as described above for second capsules, although the third capsules are distinct from the second capsules. At least one of the capsule dimensions, the capsule wall composition, and the composition of the fluid in the interior volume is different for the third capsules relative to the second capsules. The third capsules may be at least partially embedded in the first capsule wall 412, they simply may be in contact with the first capsule wall 412, or they may be in contact with the second capsules 420 without contacting the first capsule wall 412.

The third fluid may include an active agent, which may be the same as an active agent in the first or second fluids, or which may be a different active agent. The third fluid may include a healing agent. In one example, one of the fluids in a multi-capsule system includes one part of a two-polymerizer, another of the fluids includes the second part of the two-part polymerizer, and the other fluid includes an activator for the two-part polymerizer. The third fluid may include at least one other ingredient, as described above for the first and second fluids.

A method of making a multi-capsule composition includes forming an emulsion including a first fluid, a plurality of second capsules, and a continuous fluid that is immiscible with the first fluid. The second capsules include a second capsule wall defining a second interior volume and a second fluid in the second interior volume. At least a portion of the second capsules are at an interface between the first fluid and the continuous fluid in the emulsion. The method further includes forming a first capsule wall at the interface. The first capsule wall defines an interior volume that includes at least a portion of the first fluid.

Particles can be used to create stable fluid dispersions by a phenomenon known as Pickering stabilization (Pickering, S. U., Journal of the Chemical Society, Transactions 91, 2001-2021, 1907). Pickering stabilization, in which particles adhere to fluid-fluid interfaces and stabilize emulsions, offers interesting design tools for fluid encapsulation. One possible explanation for such strong adherence of particles at fluid-fluid interfaces is that the particles are partly wettable by the two phases, with the depth of the surface energy being a function of temperature, particle size, and surface tension (Finkle, P. et al. J. Am. Chem. Soc. 1923, 45, (12), 2780-2788; Pieranski, P., Phys. Rev. Lett. 45(7), 569-572, 1980). Surprisingly, microcapsules that include a fluid in the interior volume also can stabilize emulsions, such as oil/water emulsions. Thus, microcapsules may be used to create a new microcapsule and colloidosome architecture, such as the multi-capsule compositions described above.

The first fluid and the second capsules in the emulsion may be a first fluid and second capsules as described above. The continuous fluid may be any fluid that is immiscible with the first fluid. The continuous fluid preferably is not a solvent for the capsule wall of the second capsules, and preferably is not a solvent for the first capsule wall formed at the interface between the continuous fluid and the first fluid. Preferably one of the first fluid and the continuous fluid is an aqueous liquid, and the other of the first fluid and the continuous fluid is a hydrophobic liquid. More preferably the continuous fluid is an aqueous liquid, and the first fluid is a hydrophobic liquid.

Forming the emulsion may include combining ingredients and dispersing the combined ingredients. The ingredients may include the first fluid, the continuous fluid, and the plurality of second capsules. The ingredients may include at least one other substance, such as a first polymerizer, at least one additional set of capsules, or an active agent.

The dispersing the combined ingredients may be performed by a variety of techniques. Examples of dispersing techniques include high pressure jet homogenizing, vortexing, mechanical agitation, and magnetic stirring. Preferably, the dispersing includes agitation at a rate of from 300 to 1000 revolutions per minute (rpm). The diameter of the first capsule, and therefore the volume ratio between the first fluid and the second fluid, can be varied by adjusting the Pickering particle concentration and the applied shear.

The emulsion may further include a first polymerizer, which may be polymerized to form the first capsule wall. The first polymerizer may be present in the first fluid and/or in the continuous fluid. If the first polymerizer is a two-part polymerizer, it is preferred for one of the parts to be in the first fluid, and for the other part to be in the continuous fluid.

A first polymerizer may include any polymerizable substance that can be polymerized in an emulsion. In one example, the first polymerizer may include a polyurethane precursor, such as a diol, a diisocyanate, and/or a monomer containing both alcohol and isocyanate functional groups. In another example, the first polymerizer may include a urea-formaldehyde polymer precursor, such as urea and/or formaldehyde. In another example, the first polymerizer may include a gelatin precursor, such as soluble gelatin that may form gelatin by complex coacervation. In another example, the first polymerizer may include a polyurea precursor, such as an isocyanate and/or an amine such as a diamine or a triamine. In another example, the first polymerizer may include a polystyrene precursor, such as styrene and/or divinylbenzene. In another example, the first polymerizer may include a polyamide precursor, such as an acid chloride and/or a triamine.

The emulsion may further include at least one additional set of capsules, at least a portion of which may be at the interface between the first fluid and the continuous fluid in the emulsion. For example, the emulsion may further include a plurality of third capsules including a third capsule wall defining a third interior volume, and a third fluid in the third interior volume, where at least a portion of the plurality of third particles is at the interface between the first fluid and the continuous fluid in the emulsion.

The emulsion may further include an active agent, such as an active agent as described above. Preferably the active agent is in the first fluid, such that the resulting multi-capsule composition includes an active agent encapsulated within the first capsule wall. If the active agent includes a polymerizer, then this ingredient is referred to as a “second polymerizer”, to distinguish it from a first polymerizer that may form the first capsule wall. Preferably, if a first and a second polymerizer are present in the same emulsion, the two polymerizers can be polymerized separately.

The forming the first capsule wall may include forming a polymer at the interface between the first fluid and the continuous fluid. In one example, at least one of the first fluid and the continuous fluid includes a first polymerizer, and the forming the first capsule wall includes polymerizing the first polymerizer. In another example, one of the first fluid and the continuous fluid includes one part of a two-part polymerizer, and the forming the first capsule wall includes adding a second part of the two-part polymerizer to the emulsion.

In one example, a polyurethane (PU) capsule wall may be formed by the reaction of isocyanates with a diol. In another example, a urea-formaldehyde (UF) capsule wall may be formed by in situ polymerization. In another example, a gelatin capsule wall may be formed by complex coacervation. In another example, a polyurea capsule wall may be formed by the reaction of isocyanates with a diamine or a triamine, depending on the degree of crosslinking and brittleness desired. In another example, a polystyrene or polydivinylbenzene capsule wall may be formed by addition polymerization. In another example, a polyamide capsule wall may be formed by the use of a suitable acid chloride and a water soluble triamine.

Preferably the first capsule wall is formed by an emulsion polymerization in which a hydrophobic ingredient and a hydrophilic ingredient form a polymer at the interface between a hydrophobic phase and an aqueous phase of the emulsion. In one example, the polymerizer is hydrophobic, and the activator is hydrophilic. In another example, one part of a two-part polymerizer is hydrophobic, and the other part of the two-part polymerizer is hydrophilic.

The method of making a multi-capsule composition may further include forming the second capsules. The second capsules may be formed, for example, using techniques disclosed in copending U.S. patent application Ser. No. 11/756,280, filed May 31, 2007, entitled “Capsules, Methods for Making Capsules, and Self-Healing Composites Including the Same.”

In one example, the second capsules may be formed by sonicating an emulsion to form a microemulsion, where the emulsion includes water, a surfactant, a second capsule wall polymerizer and the second fluid, and polymerizing the second capsule wall polymerizer to form capsules encapsulating at least a portion of the second fluid. The emulsion may further include at least one additional ingredient, such as a buffering components, salts, acids, bases, or organic compounds that are suitable as adhesives, fibers, or costabilizers. The surfactant may include a cationic surfactant, an anionic surfactant, an amphoteric surfactant or a non-ionic surfactant. The second capsule wall polymerizer may be as described above for the first polymerizer.

The emulsion used to form the second capsules may include a costabilizer, which may help to stabilize organic phase droplets in the emulsion. The costabilizer may be a low-molecular weight compound that is insoluble in water, such as cetyl alcohol, hexadecane, octane, or n-dodecyl mercaptan. The costabilizer may be a polymer that is insoluble in water, such as poly(methyl methacrylate) or polystyrene. Preferred costabilizers include octane or hexadecane. If present, the amount of the costabilizer in the emulsion may be from 1 to 5 percent by volume (vol %), or from 2 to 4 vol %.

The emulsion used to form the second capsules may be formed by dispersing the water, the surfactant, the second capsule wall polymerizer and the second fluid. Examples of dispersing techniques include high pressure jet homogenizing, vortexing, mechanical agitation, and magnetic stirring. Preferably, the dispersing includes agitation at a rate of from 300 to 1000 rpm. Sonicating the emulsion can form a microemulsion by reducing the size of the droplets of the emulsion, such that the droplets in the microemulsion have an average diameter of 10 micrometers or less. Droplet size typically decreases with an increase in sonication power, an increase in sonication time, an increase in the amount of surfactant used, and/or a decrease in the volume fraction of the dispersed phase. The droplet size can also be affected by factors such as temperature, pressure, and the compositions of the two liquid phases. The sonicating may be performed simultaneously with at least a portion of the dispersing.

After the second capsule wall polymerizer has formed the second capsules containing at least a portion of the second fluid, the second capsules may be collected by separating the capsules from the remaining components of the microemulsion. Preferred collection methods include filtration, centrifugation, sedimentation and spray drying. The collecting optionally may include washing the second capsules, for example to remove surfactant. Examples of washing liquids include water, methanol and ethanol. The second capsules may be used as collected, or they may be dried before further use.

The multi-capsule composition may be used for a variety of applications. Particularly useful applications include those involving delivery of two or more different fluids to a single location. Examples of applications include pharmaceutical therapies, food additives, cleaning, complexing, personal care, lubrication, adhesives, heating and cooling, printing, environmental sensing, superabsorbancy, agricultural additives and self-healing composite materials.

A composite material may include a polymer matrix and a multi-capsule composition. If the multi-capsule composition includes a healing agent, the composite material may be self-healing. When the composite is subjected to a crack, the fluids from the multi-capsule composition can flow into the crack, allowing the crack faces to bond to each other or to a polymer formed in the crack. A plurality of multi-capsules may be dispersed throughout the composite, so that a crack will intersect and break one or more multi-capsules, releasing the fluids.

A multi-capsule composition in a self-healing composite material may include a first capsule, including a first capsule wall defining a first interior volume and a first fluid in the first interior volume, and a plurality of second capsules at least partially embedded in the first capsule wall. The second capsules include a second capsule wall defining a second interior volume and a second fluid in the second interior volume. At least one of the first fluid and the second fluid include a healing agent.

In one example, one of the first fluid and the second fluid comprises a polymerizer, and the other of the first fluid and the second fluid comprises an activator for the polymerizer. The healing agent may include a polymerizer for the polymer matrix, such that a polymer formed in the crack has a chemical structure that is similar to that of the polymer matrix. The healing agent may include a polymerizer for a polymer that is different from the polymer matrix. For example, it may be desirable for a polymer formed in the crack to be more rigid or less rigid than the polymer matrix.

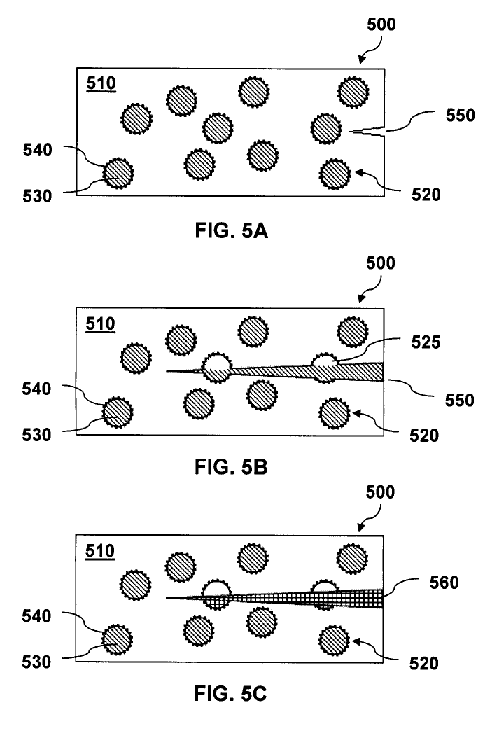

FIG. 5A illustrates an example of a composite material 500 including a polymer matrix 510 and a multi-capsule composition 520. The multi-capsule composition 520 includes a first particle 530 and a plurality of second particles 540. The multi-capsule composition 520 includes at least one healing agent, in the first capsule and/or in the second capsules. A plurality of the multi-capsules 520 is dispersed throughout the polymer matrix 510. A crack 550 has begun to form in the composite. FIG. 5B illustrates the composite material 500 when the crack 550 has progressed far enough to intersect a multi-capsule composition. Broken multi-capsule composition 525 indicates that the contents of the multi-capsule composition, including the healing agent, have flowed into the crack. FIG. 5C illustrates the composite material 500 after the healing agent has formed a polymer 560 that fills the space from the crack.

The polymer matrix may be any polymeric material into which the multi-capsule composition may be dispersed. Examples of polymer matrices include a polyamide such as nylon; a polyester such as poly(ethylene terephthalate) and polycaprolactone; a polycarbonate; a polyether; an epoxy polymer; an epoxy vinyl ester polymer; a polyimide such as polypyromellitimide (for example KAPTAN); a phenol-formaldehyde polymer such as BAKELITE; an amine-formaldehyde polymer such as a melamine polymer; a polysulfone; a poly(acrylonitrile-butadiene-styrene) (ABS); a polyurethane; a polyolefin such as polyethylene, polystyrene, polyacrylonitrile, a polyvinyl, polyvinyl chloride and poly(DCPD); a polyacrylate such as poly(ethyl acrylate); a poly(alkylacrylate) such as poly(methyl methacrylate); a polysilane such as poly(carborane-siloxane); and a polyphosphazene. Examples of polymer matrices also include elastomers, such as elastomeric polymers, copolymers, block copolymers, and polymer blends. Self-healing materials that include elastomers as the polymer matrix are disclosed, for example, in U.S. patent application Ser. No. 11/421,993 with inventors Keller et al., filed Jun. 2, 2006. The polymer matrix may include one or more other ingredients in addition to the polymeric material, such as stabilizers, antioxidants, flame retardants, plasticizers, colorants and dyes, fragrances, particulates, reinforcing fibers, or adhesion promoters.

A method of making a composite material includes combining ingredients including a multi-capsule composition and a matrix precursor, and solidifying the matrix precursor to form a polymer matrix. The matrix precursor may be any substance that can form a polymer matrix when solidified. The method may further include forming the multi-capsule composition.

In one example, the matrix precursor includes a monomer and/or prepolymer that can polymerize to form a polymer. The multi-capsule composition may be mixed with the monomer or prepolymer. The matrix precursor may then be solidified by polymerizing the monomer and/or prepolymer of the matrix precursor to form the polymer matrix.

In another example, the matrix precursor includes a polymer in a matrix solvent. The polymer may be dissolved or dispersed in the matrix solvent to form the matrix precursor, and the multi-capsule composition then mixed into the matrix precursor. The matrix precursor may be solidified by removing at least a portion of the matrix solvent from the composition to form the polymer matrix.

In another example, the matrix precursor includes a polymer that is at a temperature above its melting temperature. The polymer may be melted to form the matrix precursor and then mixed with the multi-capsule composition. The matrix precursor may be solidified by cooling the composition to a temperature below the melt temperature of the polymer to form the polymer matrix.

In one example, the polymer matrix includes a thermoset, such as a rigid thermoset. A thermoset polymer matrix may be formed by curing a matrix precursor, such that the final polymer is a crosslinked network. Curing may be performed by any of a variety of processes, such as by contact with a curing reagent, by heating, or by irradiation, such as irradiation with visible light, UV radiation, or an electron-beam. The polymer matrix may include, for example, an epoxy thermoset, a phenolic thermoset, an amino thermoset, a polyester thermoset, an allyl thermoset, a polyurethane thermoset, a dicyanate thermoset, a bismaleimide thermoset, an acrylate thermoset, or a mixture of these. See, for example, Gotro, J. et al., “Thermosets” Encyclopedia of Polymer Science and Technology, John Wiley & Sons, 2004.

A composite material including a polymer matrix and a multi-capsule composition may be used in an article, such as an aerospace vehicle or structure component, a marine vehicle component, an automobile component, a bicycle frame, a storage tank, sporting equipment, protective apparel, electronic circuit boards, prosthetics, coatings, and seals. An article that includes such a composite material may be self-healing if the multi-capsule composition includes a healing agent.

The following examples are provided to illustrate one or more preferred embodiments of the invention. Numerous variations may be made to the following examples that lie within the scope of the invention.

### EXAMPLES

### Example 1

### Synthesis of Microcapsules for Pickering Stabilization

Urea-formaldehyde (UF) microcapsules filled with dibutylphthalate (DBP) were prepared by in situ polymerization of urea and formaldehyde. An aqueous composition was prepared by combining 20 milliliters (mL) deionized water and 8.5 mL of a 5.0 wt % solution of ethylene-maleic anhydride (EMA) copolymer (Zemac-400 EMA) in water. The aqueous composition was agitated at 800 rpm, at room temperature. Once agitation had begun, a mixture of 0.50 gram (g) urea, 0.05 g resorcinol, and 0.10 g NH₄Cl was added to the composition. DBP (5.50 mL) containing a small quantity of perylene fluorescent dye was slowly added to the mixture, and agitation was continued for 10 minutes. A tapered ⅛-inch tip sonication horn of a 750-Watt ultrasonic homogenizer (Cole-Parmer) was placed in the mixture and operated for 3 minutes at 40% intensity, to provide approximately 3.0 kilojoules (kJ) of input energy, while agitation continued. This sonication changed the emulsion from slightly cloudy to opaque white.

Formalin (1.16 g; 37 wt % aqueous solution of formaldehyde) was added, to provide a 1:1.9 molar ratio of formaldehyde to urea, which polymerized to form a urea-formaldehyde polymer. The temperature was raised to 55° C. at a rate of 1° C. per minute. The mixture was agitated at 55° C. for 4 hours, after which the pH was adjusted to 3.50 with sodium hydroxide. The resulting in-water-suspended urea-formaldehyde capsules were centrifuged, decanted and redispersed five times to remove the free surfactant before use as a Pickering stabilizer. The average diameter of the microcapsules was 1.4 micrometers.

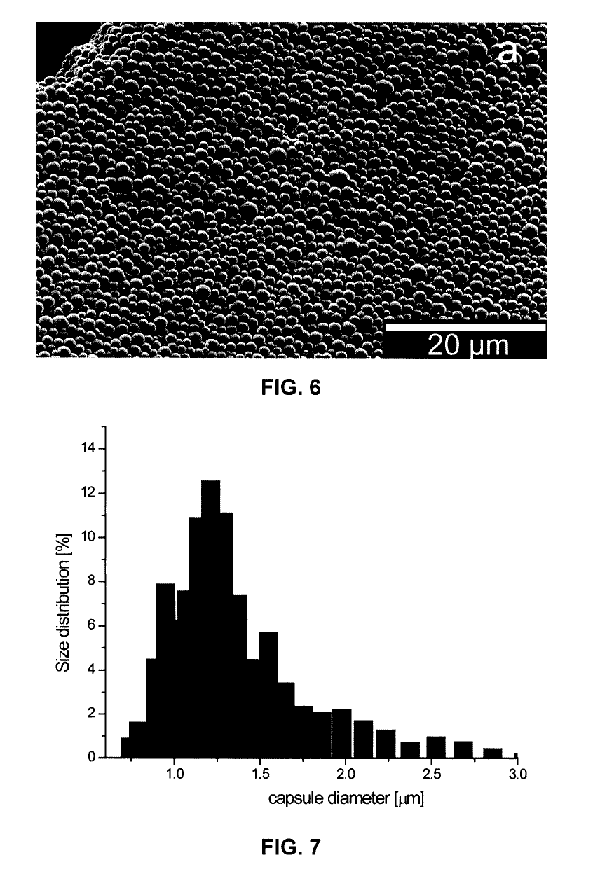

The microcapsules were imaged by Scanning Electron Microscopy (SEM) with a Hitachi and Philips scanning electron microscope. Samples of the microcapsules were deposited on carbon-coated tape and sputter-coated with gold-palladium before imaging. FIG. 6 is an SEM image of the microcapsules. The microcapsules were stable after drying and were homogeneous in size.

The size distribution of the microcapsules was determined by an AccuSizer FX focused extinction particle sizer (0.7-20 micrometers). The microcapsule-water dispersion was diluted to create a stable, semi-transparent microcapsule dispersion. Of this dispersion, 10 mL was analyzed, and sizing was performed for ˜1 million particles. An average diameter of 1.4 micrometers with a polydispersity of 1.65 was measured by focused extinction. FIG. 7 is a plot of the microcapsule size distribution.

### Example 2

### Synthesis of Multi-Capsule Composition

A multi-capsule composition including a first capsule containing dicyclopentadiene (DCPD) in its interior volume, and including a plurality of second capsules at least partially embedded in the first capsule wall, was made by using the microcapsules of Example 1 as stabilizers for an emulsion.

An emulsion was formed by combining water (50 mL), DCPD (10 mL; 9.82 g), 0.28 g of the DBP-filled UF microcapsules of Example 1, and 0.5 g of NaCl. Prior to emulsifying these ingredients, 1.5 g toluene diisocyanate-polyether prepolymer (Airthane® PHP-80D; AIR PRODUCTS; Allentown, Pa.) was dissolved in the DCPD. The mixture was emulsified and was heated to 60° C. while stirring with a mechanical impeller at 400 rpm. A polyurethane capsule shell wall was then created by the addition of 10 mL of a 1.3 M trimethylol propane (TMP) aqueous solution to the emulsion while stirring. The addition of TMP started the interfacial polymerization with the prepolymer in the oil phase. In subsequent synthetic preparations, no TMP was added; however, the prepolymer still polymerized to form a capsule shell wall. After 2.5 h reaction time, the resulting capsules were filtered, washed, sieved and dried.

The product yield was approximately 7.7 g of a free flowing powder. The capsules were designated “UF(DBP) on PU(DCPD)”, indicating that urea-formaldehyde capsules containing DBP in their interior volume were at least partially embedded in the capsule wall of polyurethane capsules containing DCPD in their interior volume.

### Example 3

### Structural Characterization of Multi-Capsule Composition

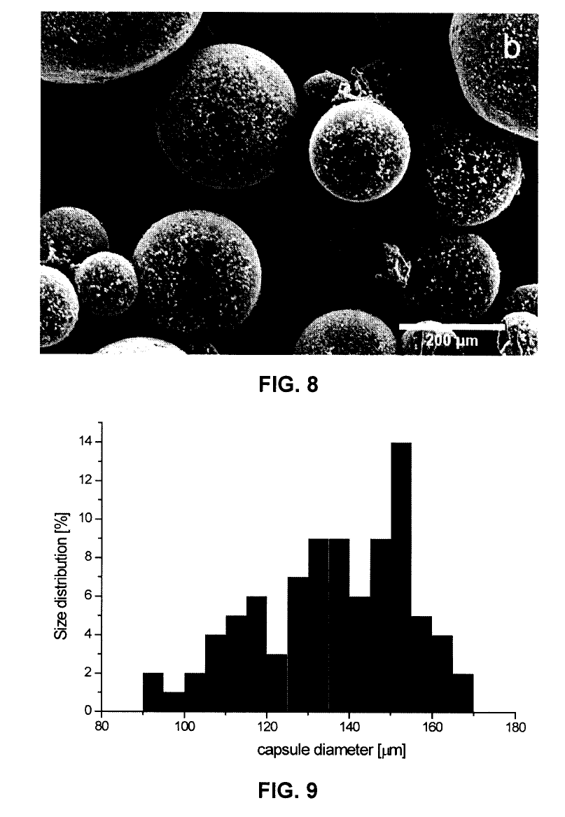

FIG. 8 is an SEM image of the UF(DBP) on PU(DCPD) capsules of Example 2. The capsules had a mean diameter of 140 micrometers and a polydispersity of 1.03, as determined from optical microscopy. FIG. 9 is a plot of the UF(DBP) on PU(DCPD) capsule size distribution. Table 1 lists the properties of the components of the UF(DBP) on PU(DCPD) capsules.

TABLE 1
Properties of UF(DBP) on PU(DCPD) Multi-Capsules

| Encapsulated | Capsule | Wall | Capsule | |
|---|---|---|---|---|
| fluid | wall | thickness | diameter | Designation |
| DBP | Urea-formaldehyde | 75 nanometers* | 1.4 micrometers | UF(DBP) |
| DCPD | Polyurethane | 3.0 micrometers | 140 micrometers | PU(DCPD) |

*From Blaiszik, B. J. et al. Composite Science and Technology, doi:10.1016/j.compscitech.2007.07.021, 2007.

As evidenced by the well formed polyurethane capsules, the DBP-filled microcapsules of Example 1 acted as Pickering stabilizers for the DCPD/water emulsion. The insolubility of the diisocyanate prepolymer in the aqueous phase, and of the optional tri-alcohol in the DCPD phase, led to an interfacial polymerization at the liquid-liquid interface. This polymerization formed a polyurethane layer between the two liquids, embedding the DBP-filled microcapsules in the capsule wall.

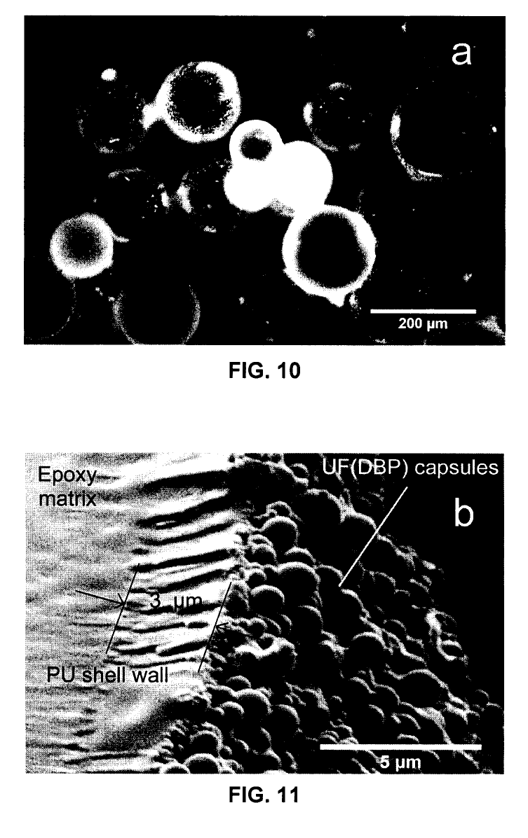

The UF(DBP) on PU(DCPD) capsules were characterized using an optical microscope in fluorescent mode (LEICA). The DBP filled UF microcapsules were made visible by excitation of the perylene dye that had been included in the liquid in the microcapsules. The dye was excited at ˜350-450 nm, and emitted at ˜450-550 nm. This allowed the location of the fluorescently tagged UF microcapsules in the multi-capsule to be determined. FIG. 10 is a fluorescent mode micrograph of the capsules. In this image, light was emitted only from the rim of the multi-capsules, indicating that the UF(DBP) microcapsules were located on the periphery of the multi-capsule surface.

### Example 4

### Release of Polymerizer From Multi-Capsule Composition

The UF(DPB) on PU(DCPD) capsules of Example 2 were combined with precursors for an epoxy thermoset to form a composite material. The epoxy precursors were EPON® 828 (MILLER-STEPHENSON; Danbury, Conn.) and diethylenetriamine curing agent Ancamine® DETA (AIR PRODUCTS; Allentown, Pa.). The EPON® 828 epoxide polymerizer included a diglycidyl ether of bisphenol A (DGEBA). The two components and the UF(DPB) on PU(DCPD) capsules were mixed, such that the EPON 828 and DETA were at a ratio of 100:12 parts per hundred (pph) by weight. The mixture was degassed for 15 minutes under vacuum at room temperature, and poured into a silicone rubber mold. The mixture was allowed to cure for 24 h at room temperature, followed by 24 h at 35° C.

After curing, the epoxy was subjected to a crack. FIG. 11 is a SEM image of a fractured multi-capsule composition embedded in the epoxy matrix. This image revealed a ductile tearing mode of the binary capsules, and confirmed the capsular architecture. A distinct layer of UF(DBP) capsules was observed at the inner surface of the ˜3-4 micrometer thick polyurethane shell wall. One possible explanation for this multi-capsule structure is that, due to the hydrophilic nature of the polyurethane polymer, the polyurethane capsule wall was created on the water side of the oil/water interface. As the UF(DBP) microcapsules firmly adhered to the interface, their final position was on the inside of the shell wall.

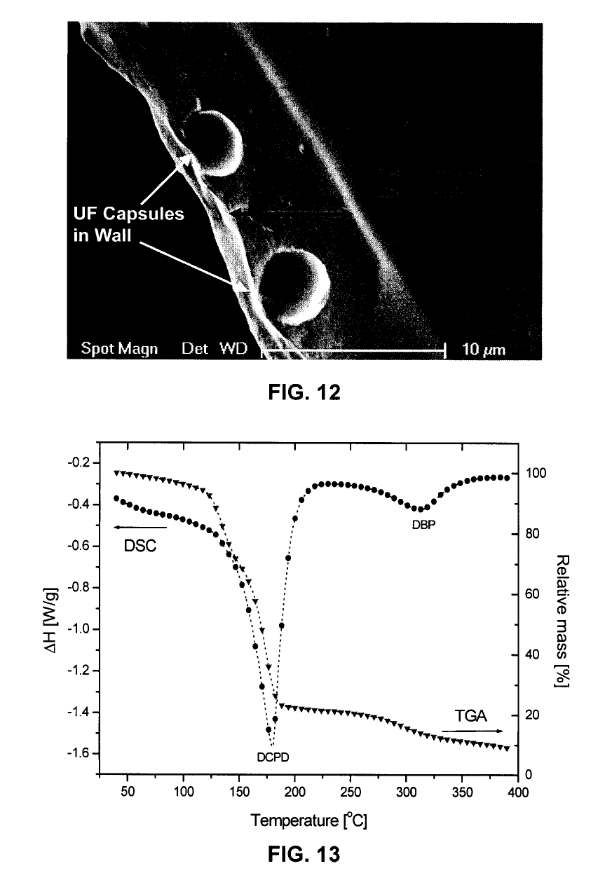

FIG. 12 is a SEM image of another a multi-capsule composition in an epoxy composite. In this image, the multi-capsule composition has been fractured, and spherical structures are visible in the polyurethane capsule wall of the first capsule. These spherical structures are believed to correlate with UF second capsules embedded in the first capsule wall.

### Example 5

### Compositional Characterization of Multi-Capsule Composition

The presence of both liquid components (DCPD and DBP) in an isolated state within the same structure was demonstrated by subjecting the binary capsules to Differential Scanning Calorimetry (DSC) and Thermo-Gravimetric Analysis (TGA) analysis. DSC and TGA experiments were performed on Mettler-Toledo equipment (DSC821e and TGA/SDTA 851e). All experiments were taken from 40° C. to 390° C., with a heating rate of 10° C./min, under flowing Nitrogen gas. DSC data analysis was done on conformable Mettler-Toledo software. The data of both thermal analyses are shown in FIG. 13, with the DSC data corresponding with the left axis, and the TGA data corresponding with the right axis.

In both experiments, two separate transition processes were observed, corresponding to the two encapsulated materials. DSC showed two endothermic peaks representing the evaporation of DCPD and DBP, with minima at 179° C. and 313° C., respectively. The heats of evaporation for both liquids were determined by integrating the endothermic peaks. The volume ratio between the two components in the multi-capsule structures was calculated using the measured specific heats of evaporation for the DCPD and DBP grades used. The experimentally determined volume ratio was defined as:

$${f}_{Vol}^{Exp} = \frac{{V}_{DBP}}{{V}_{DCPD}} = \frac{Δ {H}_{DBP}^{Trans}}{Δ {H}_{DCPD}^{Trans}} \cdot \frac{Δ {H}_{DCPD}^{Vap}}{Δ {H}_{DBP}^{Vap}} \cdot \frac{{ρ}_{DCPD}}{{ρ}_{DBP}} \qquad Eq . 1$$

where V_{DBP} and V_{DCPD} denote the volumes of the two phases. The two terms of ΔH^{Trans} represent the measured heats of evaporation for the DCPD and DBP phases from the capsules. The other parameters ΔH^{VaP} and p are the specific heat of evaporation and the density for DBP and DCPD, respectively. The measured values for these parameters are listed in Table 2.

TABLE 2
Component DSC Analysis of UF(DBP) on PU(DCPD) Multi-Capsules

| Encapsulated | | | ΔH^{Vap} | | |
|---|---|---|---|---|---|
| fluid | Tₚₑₐₖ (° C.) | ΔH^{Trans} (J) | (J) | ρ (g/cm³) | Vₓ (cm³) |
| DBP | 313 | −0.22 | −345.2 | 1.043 | 6.1 × 10⁻⁴ |
| DCPD | 179 | −2.01 | −296.3 | 0.982 | 6.9 × 10⁻³ |

Using the data listed in Table 2 and the equation above, the DBP concentration was calculated to be 8.8% by volume. TGA measurements of the multi-capsules yielded a similar DBP concentration.

Based on the average dimensions of the capsules listed in Table 1, the theoretical volume fraction of DBP was calculated, assuming uniform spherical geometries and perfect 2D square packing of the microcapsules:

$$\begin{matrix}{f}_{Vol}^{Theory} = \frac{{V}_{DBP}^{caps} \cdot {n}_{DBP}}{{V}_{DCPD}^{caps}} \\ = \frac{\frac{1}{6} \cdot π \cdot {d}^{3}}{\frac{1}{6} \cdot π \cdot {D}_{i}^{3}} \cdot \frac{π \cdot {D}_{i}^{2} \cdot ϕ}{{d}^{2}} \\ = \frac{π \cdot d \cdot ϕ}{{D}_{i}}\end{matrix} \qquad Eq . 2$$

where V^{caps} is the calculated volume for the DBP and DCPD content of a single capsule, n_{DBP} is the number of UF(DBP) capsules on a multi-capsule surface, d is the average UF(DBP) capsule diameter, Dᵢ is the inner polyurethane capsule diameter, and φ is the coverage fraction of the UF(DBP) capsules on the DCPD core surface. Dᵢ=D−2h, where h is the PU shell wall thickness. Assuming a full monolayer droplet coverage (φ=1) and using the geometric values in Table 1, the theoretical volume fraction of DBP was calculated to be 3.1%. However, from the SEM image of FIG. 11, it was clear that more than a single monolayer of capsules covered the DCPD core volume. By combining equations 1 and 2, an estimate for the experimental coverage fraction, φ_{Exp} was derived:

$${ϕ}_{Exp} = {f}_{Vol}^{Exp} \frac{{D}_{i}}{π \cdot d} \qquad Eq . 3$$

Inserting the experimental data, a coverage fraction of 2.8, close to a triple layer of UF(DBP) capsules, was obtained. The calculated coverage fraction was in close agreement with the SEM micrographs of FIG. 11. Thus, sufficient UF(DBP) capsules were present to provide a layer of capsules at least partially embedded in the PU capsule wall, and to provide 1.8 monolayers of additional UF(DBP) capsules in contact with the interior volume.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A multi-capsule composition, comprising:
a first capsule, comprising
a first capsule wall defining a first interior volume, and
a first fluid in the first interior volume;
a plurality of second capsules, at least partially embedded in the first capsule wall;
the second capsules comprising
a second capsule wall defining a second interior volume, and
a second fluid in the second interior volume.

2. The multi-capsule composition of claim 1, where
the first capsule has a diameter of from 5 to 700 micrometers, and
the second capsules have an average diameter of from 10 nanometers to 5 micrometers.

3. The multi-capsule composition of claim 1, where
the first capsule has a diameter of from 30 to 500 micrometers, and
the second capsules have an average diameter of from 10 nanometers to 2.5 micrometers.

4. The multi-capsule composition of claim 1, where the first capsule has a diameter that is at least one order of magnitude greater than an average diameter of the second capsules.

5. The multi-capsule composition of claim 1, where the first capsule has a diameter that is at least two orders of magnitude greater than an average diameter of the second capsules.

6. The multi-capsule composition of claim 1, where at least a portion of the second capsules are in contact with the first interior volume.

7. The multi-capsule composition of claim 1, where at least a portion of the second capsules are in contact with the exterior of the first capsule wall.

8. The multi-capsule composition of claim 1, further comprising an additional plurality of second capsules, which are not at least partially embedded in the first capsule wall.

9. The multi-capsule composition of claim 1, where at least one of the first fluid and the second fluid comprises an active agent selected from the group consisting of a pharmaceutical agent, a food additive, a cleaning agent, a complexing agent, a personal care substance, a lubricant, an adhesive, a heating/cooling agent, a colorant, an indicator, a superabsorbent, an agricultural additive and a healing agent.

10. The multi-capsule composition of claim 1, where at least one of the first fluid and the second fluid comprises a healing agent.

11. The multi-capsule composition of claim 10, where one of the first fluid and the second fluid comprises a polymerizer, and the other of the first fluid and the second fluid comprises an activator for the polymerizer.

12. The multi-capsule composition of claim 1, further comprising at least one additional plurality of capsules.

13. The multi-capsule composition of claim 1, further comprising a plurality of third capsules, in contact with at least a portion of the plurality of second capsules;
the third capsules comprising a third capsule wall defining a third interior volume, and a third fluid in the third interior volume.

14. The multi-capsule composition of claim 13, where
the first capsule has a diameter of from 5 to 700 micrometers,
the second capsules have an average diameter of from 10 nanometers to 5 micrometers, and
the third capsules have an average diameter of from 10 nanometers to 5 micrometers.

15. The multi-capsule composition of claim 14, where the diameter of the first capsule is at least one order of magnitude greater than the average diameter of the second capsules and the average diameter of the third capsules.

16. The multi-capsule composition of claim 13, where at least one of the first fluid, the second fluid and the third fluid comprises an active agent selected from the group consisting of a pharmaceutical agent, a food additive, a cleaning agent, a complexing agent, a personal care substance, a lubricant, an adhesive, a heating/cooling agent, a colorant, an indicator, a superabsorbent, an agricultural additive and a healing agent.

17. A method of making a multi-capsule composition, comprising:
forming an emulsion, comprising
a first fluid,
a plurality of second capsules, comprising a second capsule wall defining a second interior volume and a second fluid in the second interior volume, and
a continuous fluid, immiscible with the first fluid;
where at least a portion of the second capsules are at an interface between the first fluid and the continuous fluid; and
forming a first capsule wall at the interface, where the first capsule wall defines an interior volume comprising at least a portion of the first fluid.

18-27. (canceled)

28. A composite material, comprising:
a polymer matrix, and
the multi-capsule composition of claim 1.

29-30. (canceled)

31. A method of making the composite material of claim 28, comprising:
combining the multi-capsule composition with a matrix precursor, and
solidifying the matrix precursor to form the polymer matrix.

32-35. (canceled)

36. An article, comprising the composite material of claim 28.

37. (canceled)
